(19) United States
(12) Patent Application Publication
(10) Pub. No.: US 2022/0097095 A1
(43) Pub. Date: Mar. 31, 2022

(54) Method and Applicator for Continuous Sequential Application of Two or More Viscous Materials or Fluids

(71) Applicant: ATN Hölzel GmbH, Oppach (DE)

(72) Inventors: Uwe Schmidt, Ebersbach-Neugersdorf (DE); Bernd Scheibe, Taubenheim (DE); Uwe Haase, Oppach (DE)

(21) Appl. No.: 17/610,169

(22) PCT Filed: May 8, 2020
(86) PCT No.: PCT/DE2020/100392

§ 371 Date: Nov. 10, 2021

(30) Foreign Application Priority Data
May 10, 2019 (DE) 10 2019 112 361.5
May 14, 2019 (DE) 10 2019 112 659.2

(51) Int. Cl. B05C 11/10; B05C 5/02

(52) U.S. Cl. CPC B05C 11/1036; B05C 5/0279

(57) ABSTRACT

The purpose of the invention is to provide a method and an applicator for the continuous sequential separate application of two or more viscous materials or fluids, whereby two or more adhesives can be applied continuously in one operation in a track or line in turn or alternately or sequentially and thus different adhesives can be applied in turn without intervals as a continuous track or line or as a ring thereof.

A method for the continuous sequential application of two or more viscous materials or fluids, whereby control of the respective volume flows of the viscous materials or fluids is carried out so that the respective viscous materials or fluids are applied in turn.

Applicator for the continuous sequential application of two or more viscous materials or fluids, whereby two or more feed channels arranged adjacently in the longitudinal direction as a feed unit extending in a longitudinal direction are provided for separately guiding the viscous materials or fluids, wherein the feed channels each comprise a material outlet or fluid outlet at one axial end and the feed channels comprise a material inlet or fluid inlet in the area of the end opposite to the material outlet or fluid outlet in the longitudinal direction.

### CROSS REFERENCE TO RELATED APPLICATIONS

This application is the U.S. national stage of International Application No. PCT/DE2020/100392, filed on 2020 May 8. The international application claims the priority of DE 102019112361.5 filed on 2019 May 10 and the priority of DE 102019112659.2 filed on 2019 May 14; all applications are incorporated by reference herein in their entirety.

### BACKGROUND

The invention relates to a method and an applicator for the continuous sequential application of two or more viscous materials or fluids, for example, pasty components or adhesives, in a separate, overlapping, or successive manner.

Viscous materials or fluids include both high viscosity and low viscosity materials or fluids, to which also belong pasty materials or fluids such as pasty components or pasty adhesives. Components also include component mixtures. Likewise, adhesives also include adhesive mixtures.

The patent DE 10 2008 039 952 A1 describes a process at which two adhesives can be applied simultaneously from a coaxial nozzle. Among other things, it is provided that one adhesive is enclosed within the other adhesive, i.e. by this other adhesive, or that one adhesive is partially applied to the lateral surface of the other adhesive. Furthermore, it reveals the parallel side-by-side application of the two adhesives so that two adhesive tracks are adjacent to one another. It is not disclosed that the adhesives can be applied continuously in a track or line one after the other or alternately.

From the patent DE 198 80 257 B4, application nozzles or application needles with at least a first and a second channel are known, whereby for the formation of preferred profile shapes during the application of the sealing and shielding profile, an application needle/nozzle is used in which at least a part of the first channel circumference is surrounded by the second channel. Thus, an application needle or nozzle may be used in which the first channel has a substantially circular cross-section and is concentrically surrounded by the second channel. However, the aim of this device is to form a shielding profile from two or more different components, which are elastic hardening but optimized for different functions in a single parallel application step, whereas one component is the carrier of the other component. The discharge openings end in one plane.

The patent DE 100 46 557 B4 discloses a coaxial nozzle in which a first material is also directed towards a material stream of a second material and discharged at the discharge opening so that the second material stream completely surrounds the first material stream. In this case, the respective discharge openings for the materials are arranged at a distance from one another, whereby the distance is variably adjustable, and the coaxially inner discharge opening for the first material flow is arranged inside the nozzle or upstream of the discharge opening for the second material flow.

The patent EP 0 410 701 A2 also discloses a coaxial nozzle in which a first material is also directed towards a material flow of a second material, whereby a silicone hose is guided through a nozzle body up to a discharge opening so that the second material flow completely surrounds the first material flow.

The patent DE 1 085 307 B also discloses a coaxial nozzle discharging at least two pastes as a joint stream from a container, wherein the pastes are accommodated side by side.

The patent WO 2005/095225 A1 also discloses a coaxial nozzle dispensing from a container with separate material chambers two pasty components in the correct necessary ratio as a joint stream.

### SUMMARY

The purpose of the invention is to provide a method and an applicator for the continuous sequential separate application of two or more viscous materials or fluids, whereby two or more adhesives can be applied continuously in one operation in a track or line in turn or alternately or sequentially and thus different adhesives can be applied in turn without intervals as a continuous track or line or as a ring thereof.

A method for the continuous sequential application of two or more viscous materials or fluids, whereby control of the respective volume flows of the viscous materials or fluids is carried out so that the respective viscous materials or fluids are applied in turn.

Applicator for the continuous sequential application of two or more viscous materials or fluids, whereby two or more feed channels arranged adjacently in the longitudinal direction as a feed unit extending in a longitudinal direction are provided for separately guiding the viscous materials or fluids, wherein the feed channels each comprise a material outlet or fluid outlet at one axial end and the feed channels comprise a material inlet or fluid inlet in the area of the end opposite to the material outlet or fluid outlet in the longitudinal direction.

### DETAILED DESCRIPTION

The purpose of the invention is to provide a method and an applicator for the continuous sequential separate application of two or more viscous materials or fluids, whereby two or more adhesives can be applied continuously in one operation in a track or line one after the other or alternately or sequentially and thus different adhesives, viscous materials or fluids can be applied in turn without intervals as a continuous track or line or as a ring thereof.

An applicator in a first variation is formed as follows: An inner needle or inner tube is disposed in a hollow middle needle or middle tube and is longitudinally movable relative to the hollow middle needle or middle tube. A hollow outer needle or outer tube is further disposed around the hollow middle needle or middle tube, whereby the hollow middle needle or middle tube is longitudinally movable relative to the hollow outer needle or outer tube. A space is provided between each of the inner needle or inner tube and the hollow middle needle or middle tube, and between each of the hollow middle needle or middle tube and the hollow outer needle or outer tube to form the respective feed channel.

Extending this arrangement of the applicator, further outer or external hollow needles or tubes may be arranged around the respective hollow outer needle or outer tube, with a space between each hollow needle and tube forming the respective feed channel.

The hollow middle needle or middle tube is closed at one axial end except for a small remaining cross-section. This remaining cross-section as an opening forms an outlet. Alternatively, at an axial end of the hollow middle needle or middle tube, the cross-section is reduced to an opening forming an outlet. This outlet as an inner or first outlet is lockable by the corresponding end of the inner needle or inner tube facing this opening, thus forming a valve as an inner or first valve, needle valve, or tube valve. The inner or first valve of the inner or first outlet is lockable by corresponding movements of the inner needle or inner tube within the hollow middle needle or middle tube. The movement is made in the longitudinal direction or the axial direction.

Furthermore, the hollow outer needle or outer tube is also closed at an axial end except for a small remaining cross-section, this remaining cross-section forming an outlet as an opening. Alternatively, at an axial end of the hollow outer needle or outer tube, the cross-section is reduced to an opening forming an outlet. This outlet as an outer or second outlet is lockable by the end facing this opening with the inner or first outlet of the hollow middle needle or middle tube, thus forming a valve as an outer or second valve, needle valve, or tube valve. The outer or second valve of the outer or second outlet is lockable by corresponding movements of the hollow middle needle or middle tube in the longitudinal direction in the axial direction.

Correspondingly, the outlets and valves formed by and with the further outer or external needles and tubes respectively can be closed and opened by a corresponding movement of the respective internal needle or tube in the longitudinal direction in the axial direction.

Through the outlet, the corresponding material is released in the direction of a nozzle during and for the application. The outlet is also referred to as the material or fluid outlet in the following.

Several needles or tube valves can be nested inside each other so that interspaces are created between the needles or tubes or the formed needle valves or tube valves as feed channels or material chambers. Each of these interspaces as feed channels, hereinafter also referred to as material chamber, is supplied separately with material or fluid, for example, an adhesive or an adhesive component, via a respective material inlet or fluid inlet.

Advantageously, the feed unit comprises concentrically arranged needles, tubes or pipes, profiles or hollow profiles radially spaced apart from each other. The interiors of and/or the interspaces between the spaced needles, tubes or pipes, profiles or hollow profiles form the feed channels.

If at least one of the concentrically arranged, radially spaced needles or tubes, profiles or hollow profiles is advantageously movable in the longitudinal direction, the application of the material or the dispensing of the material flow from the material or fluid outlet will be facilitated since the respective material or fluid outlets can be moved or approached in relation to the surface on which the application is to be made.

Furthermore, the longitudinally movable feed unit and/or the longitudinally movable feed channels, as well as the longitudinally movable material outlet and the longitudinally movable needles, tubes or pipes allow the respective planes for the application to be moved or approached, the respective planes for the application or discharge of the viscous materials or fluids can be shifted in such a way that the viscous materials or fluids can be applied on the respective surface or the respective component over a shorter direct path that is less influenced by the other viscous material(s) or fluid(s) and/or be applied or discharged with a shorter range of mutual contact in a nozzle or a transition thereto.

Advantageously, the respective material outlets of the respective feed channels lie in one plane or in different planes with respect to the longitudinal direction, the planes being aligned orthogonally or diagonally with respect to the longitudinal direction, so that an application with low mutual interference is facilitated.

The material outlet's plane inclined to the longitudinal direction facilitates a directed and uniform application.

With the ends of the needles or tubes, profiles or hollow profiles arranged concentrically on the inside and radially spaced apart from each other facing the material outlet axially extend beyond the ends of the needles or tubes, profiles or hollow profiles arranged concentrically on the outside and radially spaced apart from each other, the viscous materials or fluids can be applied on the respective surface or the respective component in a way that is less influenced by the other viscous material or fluids.

The material or fluid inlets are arranged in different levels, whereby the material or fluid inlets for the material chambers situated further inside are located above the material or fluid inlets for the material chambers situated further outside.

The application process is described below using the example of an applicator designed for two materials or fluids, but analogous to the variant described, applicator design variants with several materials or fluids are also conceivable.

The application process runs as follows, for example: First, the material or fluid located in the inner material chamber of the applicator is applied. For this purpose, the inner needle as the innermost needle is retracted, the outlet as the first or inner material outlet between the inner material chamber and the nozzle is released. The middle needle or tube is in the lowest position, the outlet as the second or outer material outlet of the outer material chamber to the nozzle is closed. If the material or fluid to be discharged is now to be changed, the following process steps take place in turn:
the inner needle or tube, as the innermost, is moved downwards and thus closes the first or inner outlet of the inner material chamber to the nozzle.
the now formed functional group of middle needle or tube and inner needle or tube is moved upwards and thus releases the second or outer outlet as a material outlet between the outer material chamber and the nozzle

To switch between the material or fluid in the outer material chamber to the material or fluid in the inner material chamber, the following two process steps shall be executed in turn:
the center needle or tube and inner needle or tube function group is moved down to close the material outlet between the outer material chamber and the nozzle.
the inner needle is moved upwards to release the material outlet between the inner material chamber and the nozzle.

Deviating from the described process, further variations and operational processes are conceivable depending on the specific process requirement. It is possible to carry out the respective process steps simultaneously:
Switching from outer outlet to inner outlet: simultaneous movement of the middle needle downwards and the inner needle upwards
Switching from inner to the outer material outlet: Simultaneous movement of inner needle downwards and middle needle upwards.

The needles are preferably controlled pneumatically, but electrical control is also conceivable.

By means of a favorable configuration of the respective outlet as well as a material pressure adapted to the components and the quantity to be discharged, an approximately equal discharge volume can be achieved.

Residual amounts of one material at the nozzle outlet are displaced and applied by the other material when switching over to it. This creates a joint or transition between the components where the materials are partially mixed.

A further variant of the applicator in question is provided as a rigid or fixed or in itself and to each other rigid arrangement of tubes laid one inside the other. It shall be formed as follows: An inner needle or inner tube is arranged in a hollow middle needle or middle tube. A hollow outer needle or outer tube is also arranged around the hollow middle needle or middle tube. A space is provided between each of the inner needle or inner tube and the hollow middle needle or middle tube, and between each of the hollow middle needle or middle tube and the hollow outer needle or outer tube to form the respective feed channel.

The described needles or tubes can have a cylindrical shape but also a conical shape tapering in the direction of the material outlet.

Extending this arrangement of the applicator, further outer or external hollow needles or tubes may be arranged around the respective hollow outer needle or outer tube, with a space between each hollow needle and tube forming the respective feed channel.

At each of the tubes or needles thus nested or inserted into one another, the material inlet is located at one axial end or in the region of one of the axial ends. At the respective opposite axial end of the respective tubes or needles is the material outlet.

The axial ends of the respective tubes or needles are designed differently at the material outlet, depending on the application. For example, the ends of the tubes or needles can be arranged to lie in a plane, which can be either at right angles to the orientation or longitudinal direction of the tube or needles or at any angle thereto.

A further design variant provides for different lengths of the tubes or needles, whereby both the respective inner tubes can be longer than the respective outer tubes, and the respective outer tubes can be longer than the respective inner tubes.

As a downstream component, there is preferably a nozzle connected directly or indirectly to the material outlet end of at least the respective outer tube.

Preferably, the nozzle may have profiles or cross-sections oriented in or towards or against the direction of application to form corresponding profiling or shaping of the respective viscous material or fluid.

One or more needles or tubes may be interleaved, so that feed channels or material chambers are formed between the needles or tubes. Each of these feed channels, also referred to below as a material chamber, is supplied separately with material or fluid, for example, an adhesive or an adhesive component, via a material inlet or fluid inlet.

The material or fluid inlets are arranged in different levels, whereby the material or fluid inlets for the material chambers situated further inside are located above the material or fluid inlets for the material chambers situated further outside. Valves are attached to the material or fluid inlets, which can be designed as a needle valve or ball valve, for example, but other design shapes are also conceivable.

With the applicator according to the invention, it is achieved that the application of the respective viscous materials or fluids is carried out continuously sequentially or in succession, separately or overlapping, as required, whereby two or more adhesives, viscous materials or fluids can be applied in turn or alternately or successively in one track or line in one operation and thus different adhesives, viscous materials or fluids can be applied in turn without intervals as a continuous track or line or as a circumferential ring thereof. It is also possible to apply the different adhesives, viscous materials, or fluids at intervals. In this way, even complicated sequences of application of the respective adhesive, viscous material or fluid can be executed. Likewise, the change between the respective adhesive, viscous material or fluid can be carried out temporally, spatially or locally at any point or at any time in the course of the application, whether in a straight course or at or in a radius or a bend or any change of direction, since it is not necessary to set down the applicator or change the nozzle.

The application process is described below using the example of an applicator designed for two materials or fluids, but analogous to the variant described, applicator design variants with several viscous materials or fluids are also conceivable.

The application process runs as follows: First, the valve at the material or fluid inlet of the respective material or fluid to be applied is opened initially. The fluid or material is conveyed via the material or fluid inlet into the material chamber of the applicator and fills it. The material or fluid is then discharged through the material outlet.

If the next material or fluid is to be discharged, the valve of the material or fluid inlet of the first material chamber is closed, and the valve of the material or fluid inlet of the material chamber with the material to be applied is opened. The opening and closing of the valves can take place simultaneously or in turn, depending on the specific process requirements, whereby both the valve of the first material can be closed initially and then the valve of the second material can be opened, and the opening and closing can take place in reverse order.

By opening the valve of the material or fluid inlet of the second fluid or material, this now reaches the outlet of the applicator via the material chamber and is discharged.

Depending on the material properties of the first material or the first fluid, this remains in the respective material chamber during the application of the second component, for example, in the case of higher viscosity materials, or flows to the material outlet and is also discharged during the application of the second component.

The discharge process of further materials or fluids takes place analogously to the process described.

In further variants of the applicator, areas formed by partition walls as feed channels are in place as a feed unit extending in a longitudinal direction within a pipe, or an arrangement of tubes, pipes, or hoses lying next to one another is provided as a feed unit extending in a longitudinal direction. The material or fluid outlet is provided at one axial end and material or fluid inlet is provided in the area of the end opposite the material or fluid outlet in the longitudinal direction.

In a further variant, the material or fluid inlet is executed via the end opposite to the material or fluid outlet in a longitudinal direction of the feed channels arranged adjacent to the material or fluid outlet in a longitudinal direction, via the feed grooved disc connected to the feed channels or feed unit by means of concentrically rotating feed grooves arranged therein and the forwarding channels axially penetrating the feed grooved disc. The feed grooved disc with the feed grooves with the feed channels arranged therein and the forwarding channels axially penetrating the feed grooved disc, and the feed channels or the feed unit is concentrically rotatably arranged on a feed disc. Openings for the material or fluid inlet congruent with the position of the feed grooves are provided on the feed disc. The feed grooves are separated from each other by seals that also run around them. This facilitates a rotary movement of the feed channels or the feed unit with or without nozzle independent of the material or fluid inlet, as complicated guides for the material or fluid inlet are avoided and thus rotations of the feed channels, or the feed unit application are simplified.

Tubes, pipes, profiles, or hollow profiles having the corresponding function and arranged accordingly are also defined as a needle. The middle and outer needles are hollow and can thus also be understood as tubes, pipes or hollow profiles. The inner needle can be hollow as well as filled or hollow and closed and can thus also be understood as a tube, pipe, profile or hollow profile. If the term “needle” is not used, the simplified term “tube” is used synonymously.

For example, an inner tube, inner pipe or inner profile or inner hollow profile is arranged in a tube or pipe or hollow profile as a middle tube or middle pipe or middle hollow profile. An outer pipe or tube or outer hollow profile is arranged around the middle pipe or tube or middle hollow profile.

### BRIEF DESCRIPTION OF THE DRAWINGS

Several examples of the invention are shown in the drawings and are described in more detail below. The following is shown:

FIGS. 1 to 4 a sectional view of an applicator with three nested tubes or needles in different positions,

FIG. 5 a sectional view of an applicator with an inner tube or needle arranged in a tubular shaft as an outer tube, the respective material outlet of which is arranged in one plane,

FIG. 6 a sectional view of an applicator with an inner tube or needle arranged in a tubular shaft as an outer tube, the respective material outlet of which is arranged in a plane inclined to the longitudinal extension of the needles or tubes,

FIG. 7 a sectional view of an applicator according to FIG. 5, wherein the inner tube or needle is longer and protrudes from the outer needle or tube and the respective outlets are located in different planes,

FIG. 8 a sectional view of an applicator according to FIG. 6, wherein the inner tube or needle is longer and protrudes from the outer needle or tube and the respective outlets are located in different planes,

FIG. 9 a sectional view of an applicator according to FIG. 5, wherein the inner tube or needle is beveled and is longer and protrudes from the outer needle or tube and the inner tube or needle protrudes into a junction with a nozzle,

FIG. 10 a sectional view of an applicator according to FIG. 5, wherein the inner tube or needle is longer and protrudes from the outer needle or tube, and the respective outlets lie in different planes, and the inner tube or needle is guided into a junction with a nozzle up to its axial end,

FIG. 11 a sectional view of an applicator with a feed unit extending in a longitudinal direction with two tubes or needles as the middle and inner tubes or needles nested or arranged in a tubular shaft as the outer tube, whereby valves are formed in the area of the material outlet between the inner and middle tubes or needles or between the middle and outer tubes or needles and the material outlets are arranged in different planes.

FIG. 12 a sectional view of an applicator according to FIG. 11, whereby the outer tube or needle is extended through a junction with a nozzle and the inner and middle tubes or needles are guided to the end of the junction,

FIG. 13 a sectional view of an applicator with two tubes or needles as the middle and inner tubes or needles nested or arranged in a tubular shaft as the outer tube, the material outlet of which at the lower axial end respectively forms a valve and in the upper axial end of the tubes or needles opposite the material outlet or in the upper area thereof the material feed and the connections for a drive are provided,

FIG. 14 two sectional views in the longitudinal and cross-sectional view of an applicator, wherein the feed channels are formed by four pipes or hoses lying next to each other as a feed unit extending in a longitudinal direction,

FIG. 15 a schematic representation of an applicator, wherein the feed channels are formed by three pipes or hoses lying next to one another as the feed unit extending in a longitudinal direction,

FIG. 16 a schematic representation of an applicator, wherein the feed channels are formed by two pipes or hoses lying next to one another as the feed unit extending in a longitudinal direction,

FIGS. 17 to 19 a schematic representation of an applicator, wherein the feed channels are formed by dividing walls within a pipe or a tube as a feed unit extending in a longitudinal direction, and

FIG. 20 a schematic representation of an applicator, wherein the material inlet to a concentric arrangement of the feed channels via feed grooved disc, feed grooves and feed disc is realized.

### DETAILED DESCRIPTION OF THE PREFERRED EMBODIMENTS

The applicator according to the invention for continuous sequential application of two or more viscous materials or fluids comprises a feed unit 1 extending in a longitudinal direction with two or more feed channels 2 arranged adjacently in the longitudinal direction for separate guidance of the viscous materials or fluids. The feed channels 2 each comprise a material outlet 3 or fluid outlet 3 at one axial end. In the area of the end opposite to the material outlet 3 or fluid outlet 3 in the longitudinal direction, the feed channels 2 comprise a material inlet 4 or fluid inlet 4.

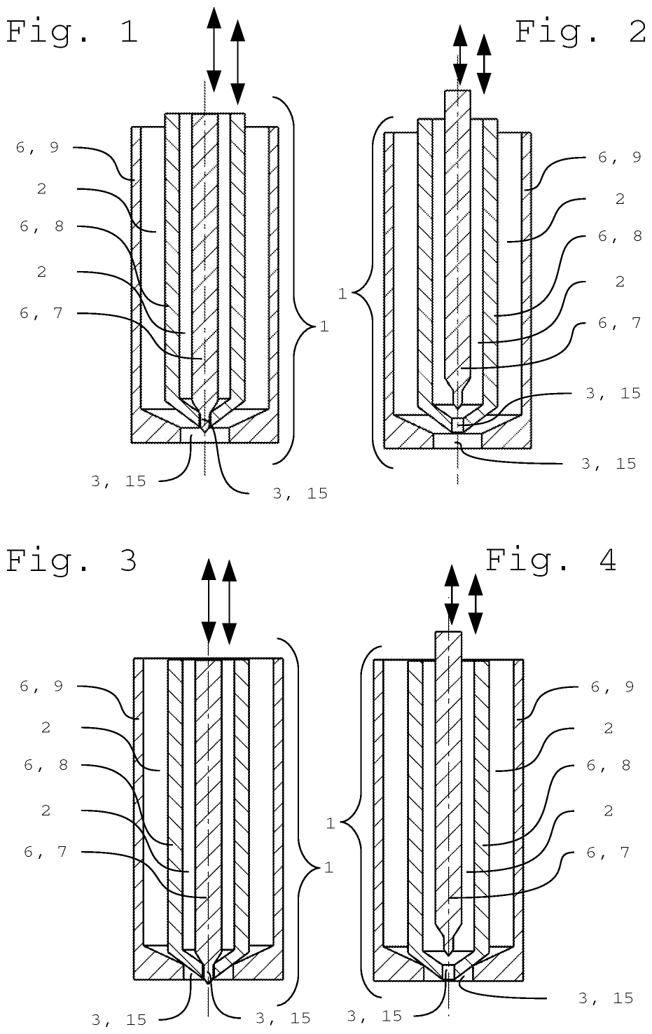

FIGS. 1 to 4 show a sectional view of an applicator with three round tubes 6 or needles 6 concentrically nested within each other, at the lower end of which the material outlet 3 is present. Between the inner tube 6, 7 or needle 6, 7 and the middle tube 6, 8 or needle 6, 8 or between the middle tube 6, 8 or needle 6, 8, and the outer tube 6, 9 or needle 6, 9 there is a space which forms the respective feed channel 2. The tubes 6 or needles 6 are shaped in the area of the material outlet 3 in such a way that valves 16 are formed in the area of the material outlet 3 between the inner tube 6, 7 or needle 6, 7 and middle tube 6, 8 or needle 6, 8 or between the middle tube 6, 8 or needle 6, 8 and outer tube 6, 9 or needle 6, 9.

The middle tube 6, 8 or needle 6, 8 and outer tube 6, 9 or needle 6, 9 each have a flange-shaped or stepped-shaped cross-sectional taper directed towards the axis of symmetry at the material outlet 3. The inner tube 6, 7 or needle 6, 7 as a full tube or needle has a stepped or stepped cross-sectional taper. The outer area or the outer end of the middle tube 6, 8 or needle 6, 8 can be moved against the respective inner area or the inner end at the material outlet 3 of the outer tube 6, 9 or needle 6, 9 and the stepped cross-sectional taper on the inner tube 6, 7 or needle 6, 7 can be moved to the respective inner area or the inner end at the material outlet 3 of the middle tube 6, 8 or needle 6, 8 and can stop or abut there, thus forming a valve 16 with which the respective material outlet 3 can be closed or opened and thus the material feed is controlled.

Accordingly, in FIG. 1 the valve 16 formed between the inner tube 6, 7 or needle 6, 7 and the middle tube 6, 8 or needle 6, 8 is closed, and the valve 16 between the middle tube 6, 8 or needle 6, 8, and the outer tube 6, 9 or needle 6, 9 is open, since, for example, the inner tube 6, 7 or needle 6, 7 and the middle tube 6, 8 or needle 6, 8 have been moved upwards together and equally.

FIG. 2 represents the valves 16 formed being open between the inner tube 6, 7 or needle 6, 7 and the middle tube 6, 8 or needle 6, 8 or between the middle tube 6, 8 or needle 6, 8, and the outer tube 6, 9 or needle 6, 9 as, for example, the inner tube 6, 7 or needle 6, 7 and the middle tube 6, 8 or needle 6, 8 having been moved upwards together independently, whereby the inner tube 6, 7 or needle 6, 7 have traveled a longer distance.

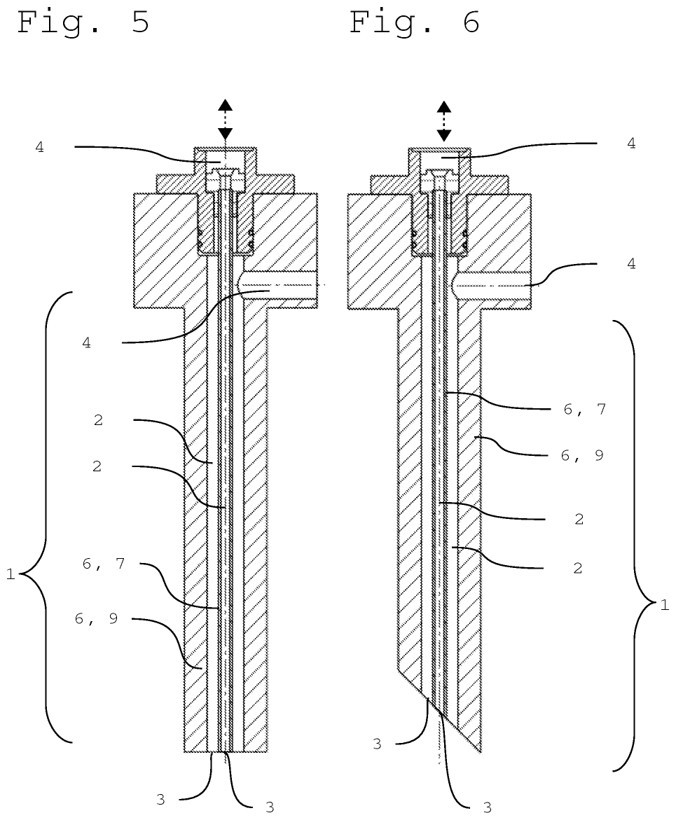

FIG. 3 represents the valves 16 formed being closed between the inner tube 6, 7 or needle 6, 7 and the middle tube 6, 8 or needle 6, 8 resp. between the middle tube 6, 8 or needle 6, 8, and the outer tube 6, 9 or needle 6, 9 as, for example, the stepped cross-sectional taper on the inner tube 6, 7 or needle 6, 7 is adjacent to the respective inner area or inner end at the material outlet 3 of the middle tube 6, 8 or needle 6, 8 and the outer area or end of the middle tube 6, 8 or needle 6, 8 having been moved to and is in contact with the respective inner area or end at the material outlet 3 of the outer tube 6, 9 or needle 6, 9.

FIG. 4 represents the valve 16 formed between the inner tube 6, 7 or needle 6, 7 and the middle tube 6, 8 or needle 6, 8 being open and the valve 16 between the middle tube 6, 8 or needle 6, 8, and the outer tube 6, 9 or needle 6, 9 being closed as, for example, the inner tube 6, 7 or needle 6, 7 has been moved upwards.

Thus, for example, by means of an applicator, exemplarily shown in FIGS. 1 to 4, the method according to the invention can be carried out, whereby control of the respective volume flows of the viscous materials or fluids takes place, so that the respective viscous materials or fluids are applied in turn and thus the application can take place continuously or spaced apart and also an overlapping or superimposition of the respective preceding material or fluid and the respective following material or fluid is possible, wherein a valve 16 at the respective material inlet 4 or fluid inlet 4 and/or a valve 16 at the respective material outlet 3 or fluid outlet 3 is controlled for the respective volume flow. The control of the respective volume flows can be carried out abruptly or with overlapping or proportionally.

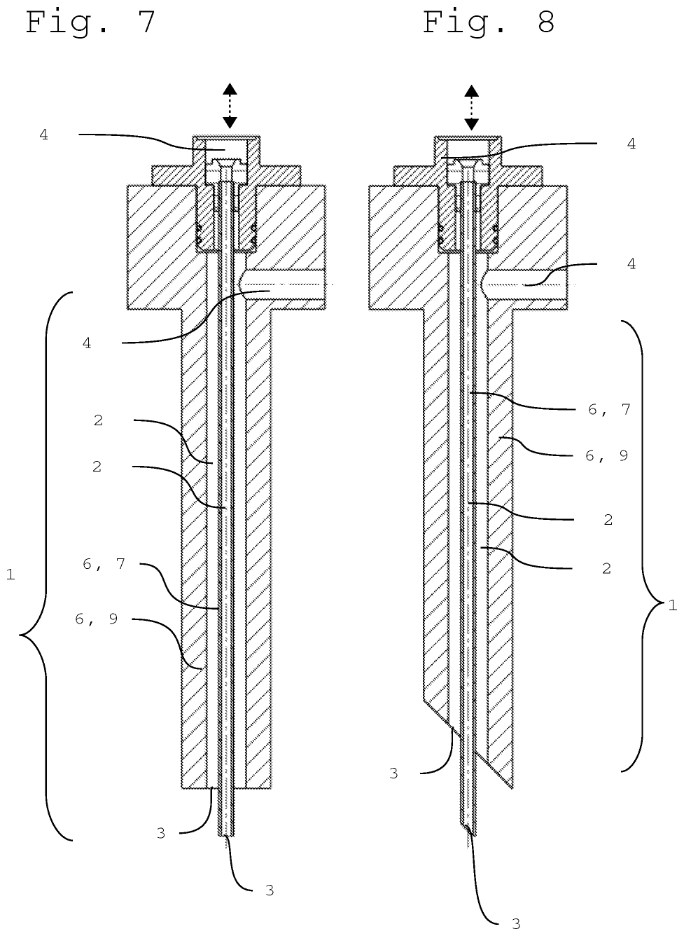

A further applicator according to the invention is shown in FIG. 5 as a sectional view. A feed unit 1 extending in a longitudinal direction has a tubular shaft as an outer tube 6, 9 with an inner tube 6, 7 or needle 6, 7 arranged therein. The material outlet 3 is present at the respective lower axial end of the inner tube 6, 7 or needle 6, 7 and the outer tube 6, 9 or needle 6, 9. In the inner tube 6, 7 or needle 6, 7, there is an inner space, and between the inner tube 6, 7 or needle 6, 7 and the outer tube 6, 9 or needle 6, 9 there is a space forming the respective feed channel 2. The material outlets 3 of the inner tube 6, 7 or needle 6, 7 and the outer tube 6, 9 or needle 6, 9 lie in a plane which is designed at right angles to the longitudinal extension of the feed unit. In the upper axial end of the inner tube 6, 7 or needle 6, 7 and the outer tube 6, 9 or needle 6, 9 opposite to the material outlet 3 or in the upper area thereof, the material feed 4 and the connections for a drive are provided.

The design of a further applicator according to the invention in FIG. 6 corresponds essentially to the applicator in FIG. 5, whereby, in deviation from FIG. 5, the material outlets 3 of the inner tube 6, 7 or needle 6, 7 and the outer tube 6, 9 or needle 6, 9 lie in one plane, but the plane is designed or aligned obliquely or at an angle to the longitudinal extension of the feed unit 1.

The models shown in FIGS. 5 and 6 allow the inner tube 6, 7 or needle 6, 7 to be moved axially upwards so that the material outlet 3 of the inner tube 6, 7 or needle 6, 7 can be moved into a deviating plane in the outer tube 6, 9 or needle 6, 9.

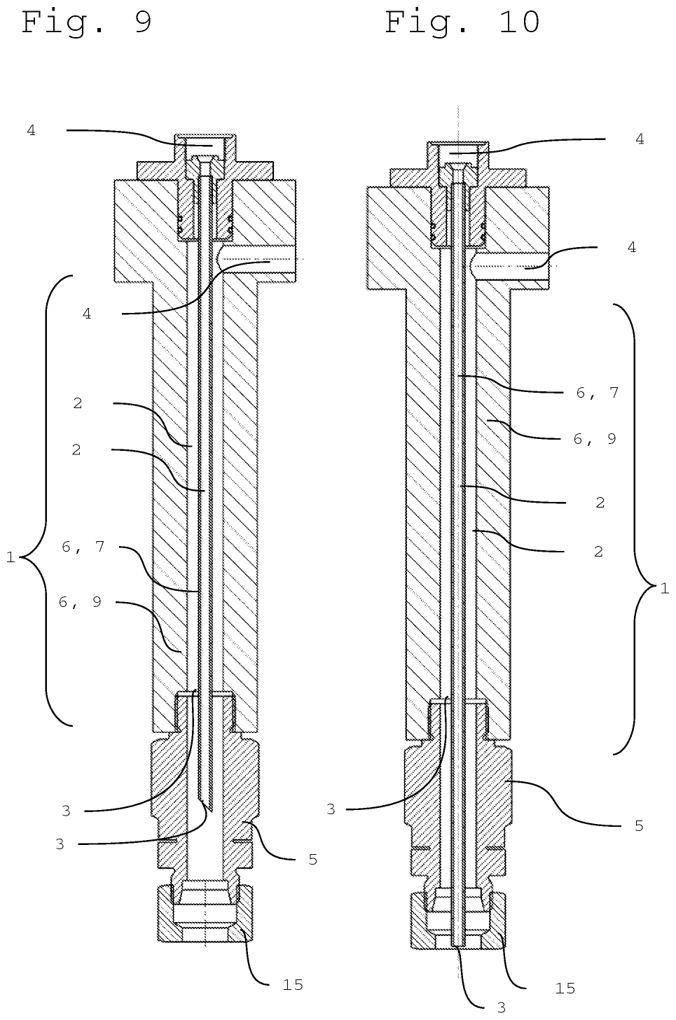

The design of a further applicator according to the invention in FIG. 7 corresponds essentially to the applicator in FIG. 5, whereby, in contrast to FIG. 5, the inner tube 6, 7 or needle 6, 7 is longer and projects from the outer needle 6, 9 or tube 6, 9 and thus the respective material outlets 3 lie in different planes.

The variants of a further applicator according to the invention in FIG. 8 corresponds essentially to the applicator in FIG. 6, whereby, in deviation from FIG. 5, the material outlets 3 of the inner tube 6, 7 or needle 6, 7 and of the outer tube 6, 9 or needle 6, 9 do not lie in one plane and the respective planes of the material outlets 3 are, however, constructed or aligned obliquely or at an angle to the longitudinal extension of the feed unit 1.

The variants shown in FIGS. 7 and 8 allow an axial movement of the inner tube 6, 7 or needle 6, 7 upwards so that the material outlet 3 of the inner tube 6, 7 or needle 6, 7 can be moved into a further deviating or the same plane of the material outlet 3 of the outer tube 6, 9 or needle 6, 9.

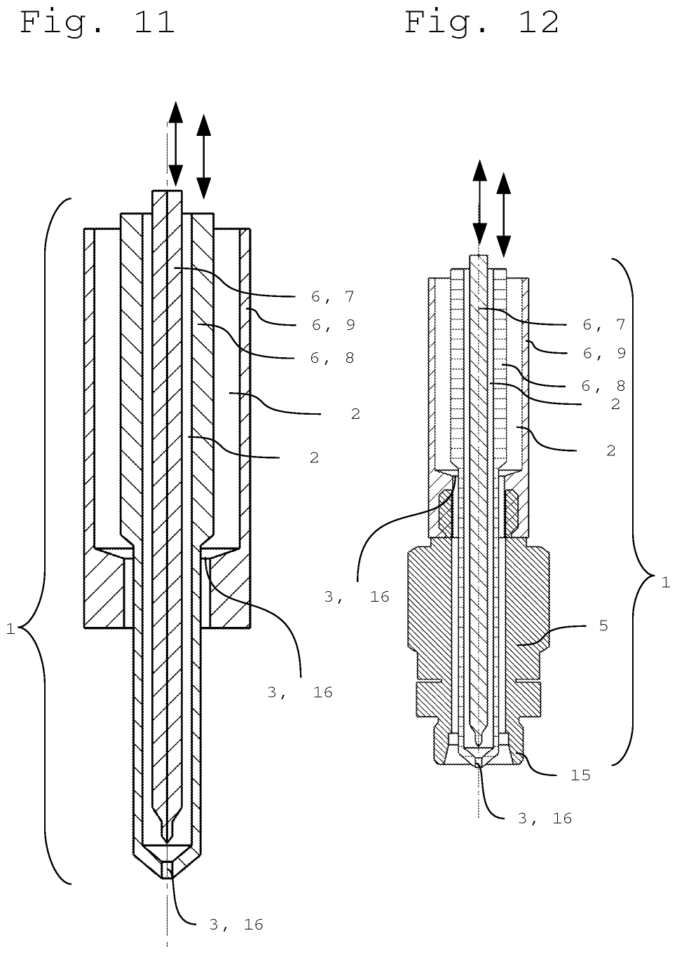

The design of a further applicator according to the invention in FIG. 9 corresponds essentially to the applicator in FIG. 5, whereby, in contrast to FIG. 5, the inner tube 6, 7 or needle 6, 7 is longer and projects from the outer needle 6, 9 or tube 6, 9 and thus the respective material outlets 3 lie in different planes. In addition, the material outlet 3 of the inner tube 6, 7 or needle 6, 7 is beveled. There is junction 5 with a nozzle 15 at the feed unit 1 or at the material outlet 3 of the outer tube 6, 9 or needle 6, 9. The inner tube 6, 7 or needle 6, 7 projects into junction 5 with nozzle 15 without reaching nozzle 15.

The design of a further applicator according to the invention in FIG. 10 corresponds essentially to the applicator in FIG. 5, whereby, in contrast to FIG. 5, the inner tube 6, 7 or needle 6, 7 is longer and projects from the outer needle 6, 9 or tube 6, 9 and thus the respective material outlets 3 lie in different planes. There is junction 5 with a nozzle 15 at the feed unit 1 or at the material outlet 3 of the outer tube 6, 9 or needle 6, 9. The inner tube 6, 7 or needle 6, 7 projects into junction 5 with nozzle 15 and extends to nozzle 15. The nozzle 25 and the material outlet 3 lie approximately in one plane.

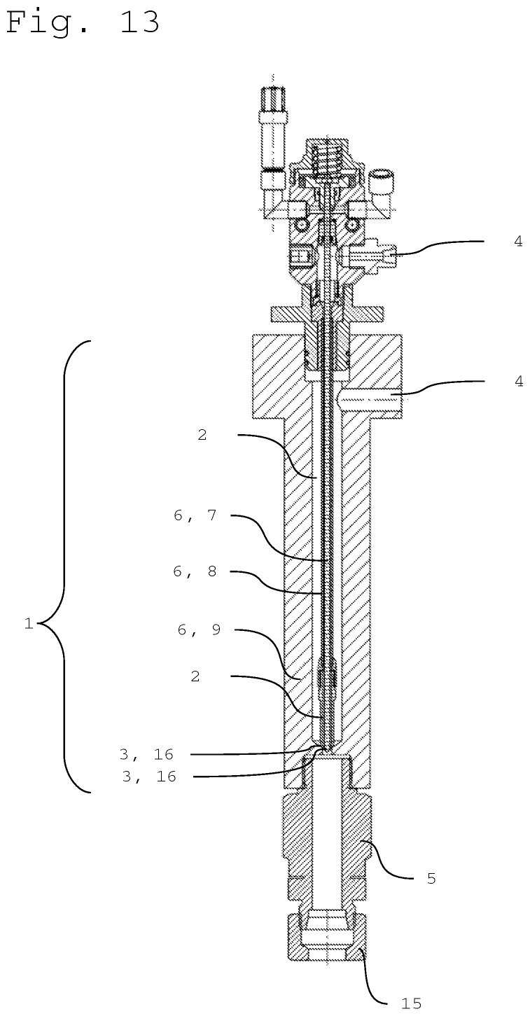

A variant of a further applicator according to the invention is shown in FIG. 11. A sectional view shows the applicator with a feed unit 1 extending in a longitudinal direction with two tubes 6 or needles 6 coaxially nested or arranged in a tubular shaft as outer tube 6, 9 as middle tube 6, 8 or needle 6, 8 and inner tube 6, 7 or needle 6, 7, wherein the inner tube 6, 7 or needle 6, 7 is designed as a full material, at the lower axial end of which the material outlet 3 is present. Between the inner tube 6, 7 or needle 6, 7 and the middle tube 6, 8 or needle 6, 8 or between the middle tube 6, 8 or needle 6, 8 and outer tube 6, 9 or needle 6, 9 there is in each case a space forming the respective feed channel 2. The respective tubes 6 or needles 6 are shaped in the area of the material outlet 3, as compared to FIGS. 1 to 4, in such a way that in the area of the material outlet 3 between the inner tube 6, 7 or needle 6, 7 and the middle tube 6, 8 or needle 6, 8 or between the middle tube 6, 8 or needle 6, 8 and
the outer tube 6, 8 or needle 6, 9 there is an area forming the respective feed channel 2. The inner tube 6, 7 or needle 6, 7 and the middle tube 6, 8 or needle 6, 8 are longer than the outer tube 6, 9 or needle 6, 9 and project axially from it. The inner tube 6, 7 or needle 6, 7 is movable within the middle tube 6, 8 or needle 6, 8 and the middle tube 6, 8 or needle 6, 8 is movable within the outer tube 6, 9 or needle 6, 9 and form respective valves 16 at the material outlets 3 of the respective feed channels 2. The area of the middle tube 6, 8 or needle 6, 8 being inside the outer tube 6, 9 or needle 6, 9 has a larger outer diameter than the area outside the outer tube 6, 9 or needle 6, 9 to form the valve 16. The outer diameter decreases abruptly in the area of the material outlet 3 of the feed channel 2 between the outer tube 6, 9 or needle 6, 9 and the middle tube 6, 8 or needle 6, 8 to form the valve 16 as a stepped or tiered cross-sectional taper. In the upper axial end of the tubes 6 or needles 6 opposite to the material outlet 3, or in the upper area thereof, the material feed 4 and the connections for a drive are provided.

The variant of a further applicator according to the invention in FIG. 12 corresponds essentially to the applicator in FIG. 11, whereby, deviating from FIG. 11, junction 5 with a nozzle 15 is present in the area of or at the material outlet 3 of the feed channel 2 between the outer tube 6, 9 or needle 6, 9 and the middle tube 6, 8 or needle 6, 8, whereby the inner tube 6, 7 or needle 6, 7 and the middle tube 6, 8 or needle 6, 8 are guided through junction 5 with nozzle 15 or extend to nozzle 15. The material outlet 3 of the feed channel 2 between the inner tube 6, 7 or needle 6, 7 and the middle tube 6, 8 or needle 6, 8 lies approximately in the plane of nozzle 15.

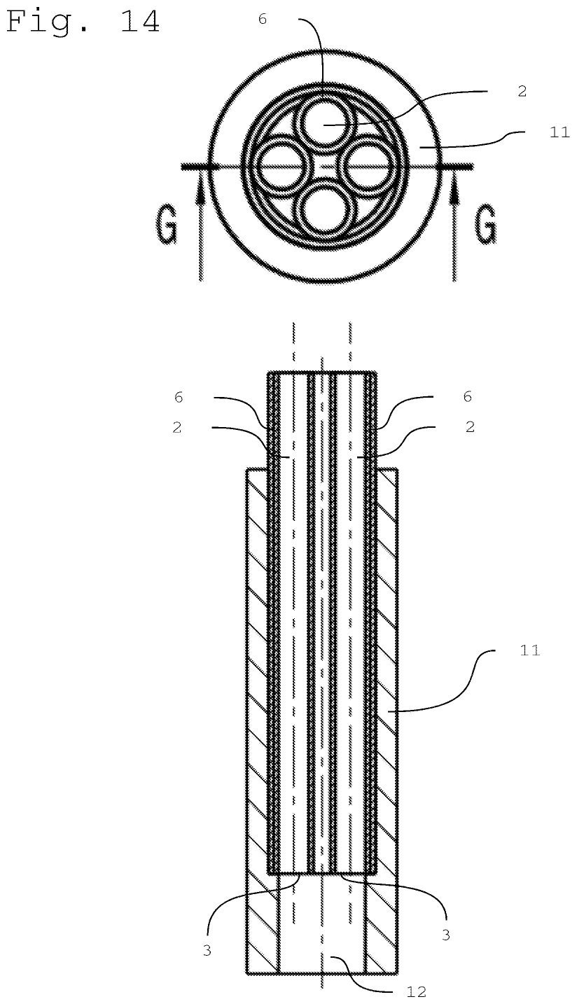

The variant of a further applicator according to the invention in FIG. 13 shows a sectional view of an applicator with a feed unit 1 extending in a longitudinal direction with two tubes 6 or needles 6, 9 coaxially nested or arranged in a tubular shaft as the outer tube 6, 9 arranged coaxially in a tubular shaft as outer tube 6, 9 as a middle tube 6, 8 or needle 6, 8 and inner tube 6, 7 or needle 6, 7, whereby the inner tube 6, 7 or needle 6, 7 is designed as a full material, at the lower axial end of which the material outlet 3 is present. Between the inner tube 6, 7 or needle 6, 7 and the middle tube 6, 8 or needle 6, 8 or between the middle tube 6, 8 or needle 6, 8 and outer tube 6, 9 or needle 6, 9 there is in each case a space forming the respective feed channel 2. The respective tubes 6 or needles 6 are shaped in the area of the material outlet 3, as compared to FIGS. 1 to 4, in such a way that valves 16 are formed in the area of the material outlet 3 between the inner tube 6, 7 or needle 6, 7 and the middle tube 6, 8 or needle 6, 8 or between the middle tube 6, 8 or needle 6, 8 and outer tube 6, 9 or needle 6, 9. Axially aside from the material outlet 3, the feed unit 1 is axially extended at the outer tube 6, 9 or the needle 6, 9. At this extension, junction 5 with a nozzle 15 is arranged. In the upper axial end of the tubes 6 or needles 6 opposite to the material outlet, or in their upper area, the material feed 4 and the connections for a drive are provided. In the upper axial end of the tubes 6 or needles 6 opposite to the material outlet 3, or in the upper area thereof, the material feed 4 and the connections for a drive are provided.

The variant of a further applicator according to the invention in FIG. 14 shows two longitudinal and cross-sectional views of an applicator, wherein the feed channels 2 as a feed unit 1 extending in a longitudinal direction are formed by four pipes 6 or hoses 6 lying next to one another, which are additionally surrounded by a pipe section 11, wherein the axial ends of the feed channels 2 for the material outlets 3 lie within the pipe section 33 and the lower end of the pipe section forms a further or common material outlet 12.

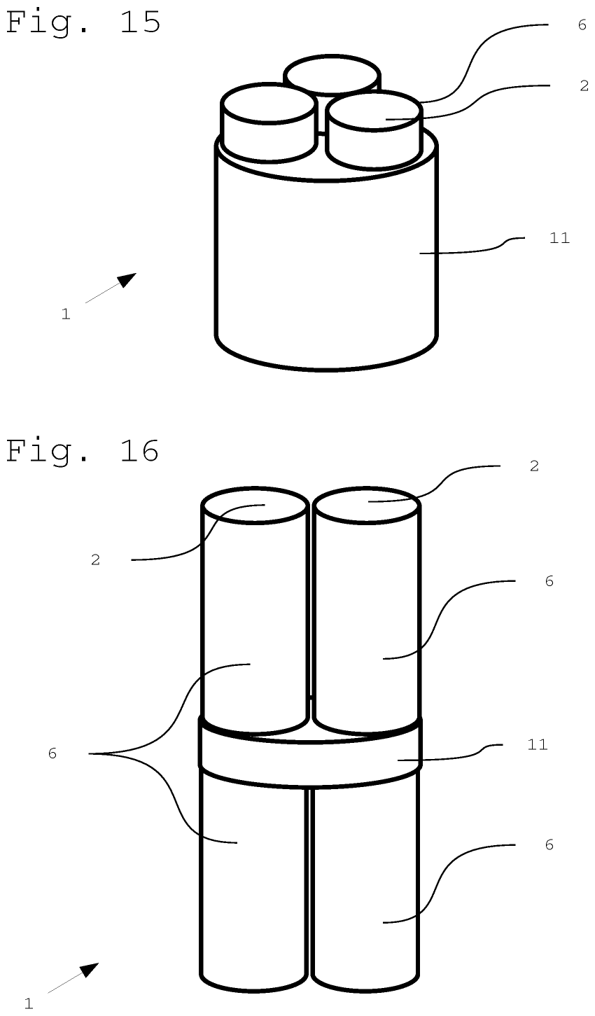

The variant of a further applicator according to the invention in FIG. 15 shows a schematic representation of an applicator, wherein the feed channels 2 as a feed unit 1 extending in a longitudinal direction are formed by three pipes 6 or hoses 6 lying next to one another, which are additionally surrounded by a pipe section 11.

The variant of a further applicator according to the invention in FIG. 16 shows a schematic representation of an applicator, wherein the feed channels 2 as a feed unit 1 extending in a longitudinal direction are formed by two pipes 6 or hoses 6 lying next to one another, which are surrounded in areas by a fixing 11.

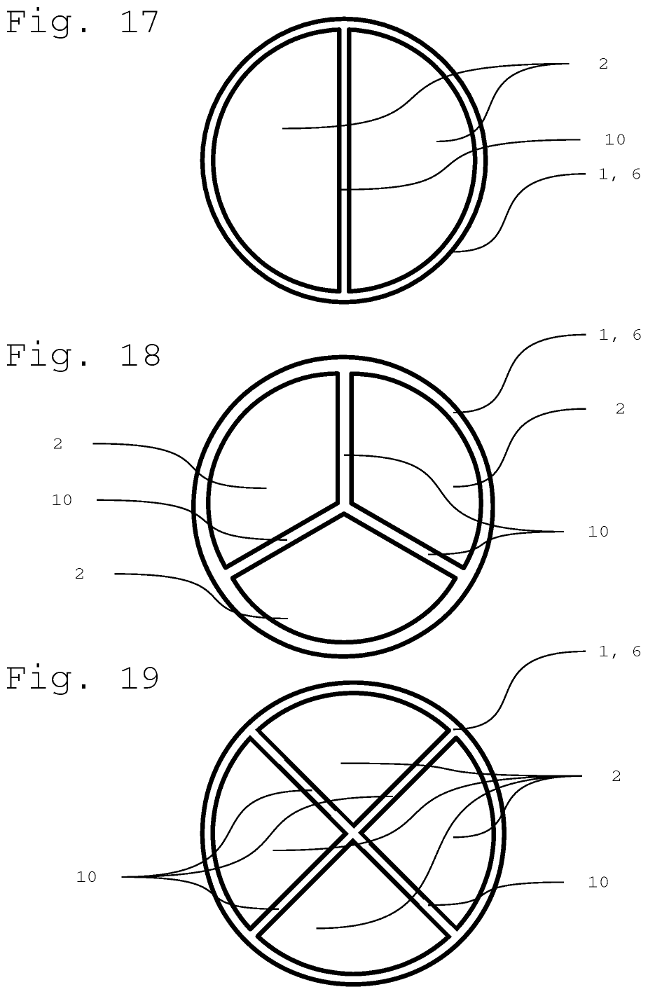

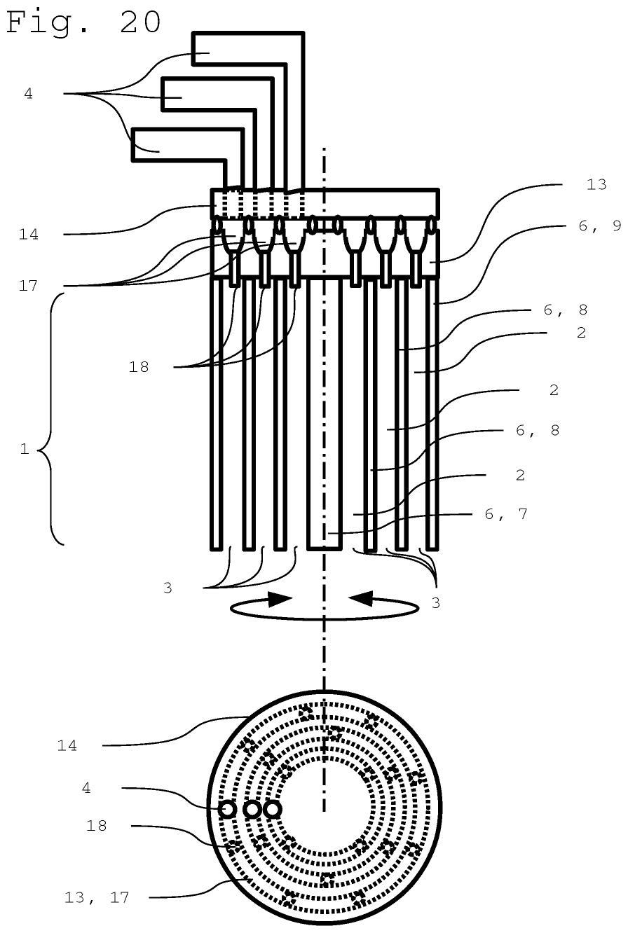

The variant of a further applicator according to the invention in FIGS. 17 to 19 shows a schematic representation or a sectional view of an applicator, wherein the feed channels 2 as a feed unit 1 extending in a longitudinal direction are formed by partition walls 10 within a pipe 6 or a tube 6. Accordingly, for example, the pipe 6 or the tube 6 can be divided into two, three or four feed channels 2, whereby the partition walls 10 are suitably provided and arranged. At this, distribution or arrangement of the partition walls and the feed channels 2 deviating from the distribution or arrangement of the partition walls 10, which are uniform in cross-section, are also possible.

The variant of a further applicator according to the invention in FIG. 20 shows a schematic representation of an applicator, in which the material inlet 4 to a concentric arrangement of the feed channels 2 of the feed unit 1 is realized via a feed grooved disk 13 with feed grooves 17 with feed-through channels 18 and feed disk 14 distributed therein and axially penetrating the feed groove disk 13. The advantage here is that in the event of a rotational movement or change in the direction of the feed unit 1, which may occur during an application, in particular, in the case of radii to be applied, the material inlet 4 does not have to perform this rotational movement as well, since the material inlet 4 is arranged on a feed disc 14 which is not necessarily rotatable and a feed groove disc 13 with rotationally symmetrical feed grooves 17 and the feed-through channels 18 distributed therein and axially penetrated the feed grooved disc 13 is rotatably arranged on the feed disc 14. The respective material inlets 4 are arranged on different radii starting from the center of the rotationally symmetrical feed disc 14. Corresponding to these radii, the rotationally symmetrical feed grooves 17 are arranged on or in the rotationally symmetrical feed grooved disk 13. The feed-through channels 18 distributed in the feed grooves 17 and axially penetrated the feed grooved disk 13, open into the concentrically arranged feed channels 2 of the feed unit 1, which can thus be rotated independently of the material inlets 4.

### LIST OF REFERENCE NUMERALS

1—feed unit

2—feed channel

3—material outlet, fluid outlet, outlet

4—material inlet, fluid inlet

5—junction

6—needle, pipe, tube, profile, hollow profile, hose

7—inner needle, inner tube

8—middle needle, middle tube

9—outer needle, outer tube

10—partition wall

11—pipe section, fixing

12—further, common material outlet

13—feed grooved disc, feed groove

14—feed disc

15—nozzle

16—valve

17—feed groove

18—feed-through channel

1. A method for the continuous sequential application of two or more viscous materials or fluids, whereby control of the respective volume flows of the viscous materials or fluids is carried out so that the respective viscous materials or fluids are applied in turn.

2. Procedure according to claim 1,
characterized in
that the application is carried out in a continuous or spaced manner without intervals.

3. Procedure according to claim 1,
characterized in
that an overlapping or superimposition of the respective previous material or fluid and the respective subsequent material or fluid takes place.

4. Procedure according to claim 1,
characterized in
that the application of the two or more viscous materials or fluids is carried out by means of an applicator, a valve (16) at the respective material inlet (4) or fluid inlet (4) and/or a valve (16) at the respective material outlet (3) or fluid outlet (3) being controlled for the respective volume flow.

5. Procedure according to claim 1,
characterized in
that the control of the respective volume flows takes place abruptly or with overlaps or proportionally.

6. Applicator for the continuous sequential application of two or more viscous materials or fluids, whereby two or more feed channels (2) arranged adjacently in the longitudinal direction as a feed unit (1) extending in a longitudinal direction are provided for separately guiding the viscous materials or fluids, wherein the feed channels (2) each comprise a material outlet (3) or fluid outlet (3) at one axial end and the feed channels (2) comprise a material inlet (4) or fluid inlet (4) in the area of the end opposite to the material outlet (3) or fluid outlet (3) in the longitudinal direction.

7. The applicator according to claim 6,
characterized in
that the material outlets (3) or fluid outlets (3) open into or are guided to a nozzle (15) or into a junction (5) with a nozzle (15) or merge into the junction (5).

8. The applicator according to claim 6,
characterized in
that the feed channels (2) have a circular ring-shaped, circular cut-out-shaped or circular segment-shaped cross-section or a round and/or angular cross-section.

9. The applicator according to claim 6,
characterized in
that the feed unit (1) comprises concentrically arranged needles (6), pipes (6), or tubes (6), profiles (6) or hollow profiles (6) which are radially spaced apart from one another, and the inner spaces of and/or the spaces between the spaced needles (6), pipes (6) or tubes (6), profiles (6), or hollow profiles (6) form the feed channels (2).

10. The applicator according to claim 6,
characterized in
that the feed unit (1) is a needle (6), a pipe (6), a tube (6), or a hollow profile (6), whereby two or more feed channels (2) are formed by at least one longitudinally extending partition (10) lying inside the needle (6), the pipe (6), the tube (6), or the hollow profile (6).

11. The applicator according to claim 6,
characterized in
that the feed unit (1) comprises individual pipes (6), tubes (6), or hoses (6) lying next to one another, the respective pipes (6), tubes (6), or hoses (6) forming the feed channels (2).

12. The applicator according to claim 6,
characterized in
that the feed unit (1) and/or the feed channels (2) are longitudinally movable and/or that the respective material outlet (3) is longitudinally displaceable.

13. The applicator according to claim 6,
characterized in
that at least one of the concentrically arranged needles (6) or tubes (6), profiles (6) or hollow profiles (6) radially spaced apart from each other is movable in the longitudinal direction.

14. The applicator according to claim 6,
characterized in
that the material outlet (3) of the respective feed channel (2) comprises or forms a valve (16) and/or comprises a cross-sectional taper.

15. The applicator according to claim 6,
characterized in
that the respective material outlet (3) forms a valve (16) between two needles (6) or tubes (6), profiles (6) or hollow profiles (6), which are arranged concentrically in a movable manner in the longitudinal direction and are radially spaced apart from one another.

16. The applicator according to claim 6,
characterized in
that the respective material outlets (3) of the respective feed channels (2) lie in one plane or in different planes in relation to one another with respect to the longitudinal direction, whereby the respective plane are oriented orthogonally or obliquely or at an angle to the longitudinal direction.

17. The applicator according to claim 6,
characterized in
that the ends of the needles (6) or tubes (6), profiles (6) or hollow profiles (6) arranged concentrically in each case on the inside and radially spaced apart from one another and pointing towards the material outlet (3) project axially beyond the ends of the needles (6) or tubes (6), profiles (6) or hollow profiles (6) arranged concentrically therewith in each case on the outside and radially spaced apart from one another.
